(19) United States
(12) Patent Application Publication
(10) Pub. No.: US 2025/0361186 A1
(43) Pub. Date: Nov. 27, 2025

(54) METHOD FOR THE TREATMENT OF POROUS GRAPHITE SUBSTRATES, TREATED SUBSTRATE AND ITS USE

(71) Applicant: FRAUNHOFER-GESELLSCHAFT ZUR FÖRDERUNG DER ANGEWANDTEN FORSCHUNG E.V., München (DE)

(72) Inventors: Felix STURM, Erlangen (DE); Christian REIMANN, Erlangen (DE); Chloé SEIMETZ, Erlangen (DE); Matthias TREMPA, Erlangen (DE)

(73) Assignee: FRAUNHOFER-GESELLSCHAFT ZUR FÖRDERUNG DER ANGEWANDTEN FORSCHUNG E.V., München (DE)

(21) Appl. No.: 19/211,701

(22) Filed: May 19, 2025

(30) Foreign Application Priority Data
May 21, 2024 (EP) 24176993

(51) Int. Cl. C04B 35/52; C04B 35/634; C04B 35/636; C04B 35/65; C04B 35/657; F27B 17/00

(52) U.S. Cl. CPC C04B 35/522; C04B 35/63488; C04B 35/6365; C04B 35/65; C04B 35/657; C04B 2235/3826; C04B 2235/425; C04B 2235/428; C04B 2235/5427; C04B 2235/5436; C04B 2235/612; C04B 2235/616; C04B 2235/6567; C04B 2235/6581; C04B 2235/9684; F27B 17/00

(57) ABSTRACT

The present invention relates to a method for treating porous graphite substrates, in which at least one film is provided, the at least one film comprising silicon particles and at least one binding agent, the at least one film is applied to at least one surface of a porous graphite substrate, and the at least one applied film is subjected to at least one heat treatment in which the silicon particles melt into a melt which at least partially infiltrates into pores of the graphite substrate, wherein silicon contained in the melt is at least partially converted into silicon carbide. In addition, the present invention also relates to a treated substrate and its use.

### CROSS-REFERENCE TO RELATED APPLICATIONS

This patent application claims the benefit of European Patent Application No. 24 176 993.4, filed May 21, 2024, which is incorporated by reference in its entirety for all purposes.

### BACKGROUND OF THE INVENTION

The present invention relates to a method for treating porous graphite substrates, in which at least one film is provided, the at least one film comprising silicon particles and at least one binding agent, the at least one film is applied to at least one surface of a porous graphite substrate, and the at least one applied film is subjected to at least one heat treatment in which the silicon particles melt into a melt which at least partially infiltrates into pores of the graphite substrate, wherein silicon contained in the melt is at least partially converted into silicon carbide. In addition, the present invention also relates to a treated substrate and its use. In the context of the present invention, the at least one film can also be referred to as at least one foil.

The production and processing of semiconductor materials (silicon, silicon carbide, nitrides) is dependent on the availability of dense graphite components with ceramic protective coatings for the operation of production systems. The protective layer ensures that graphite corrosion (e.g., due to oxidizing or reducing media) is minimized during semiconductor material processing and that the service life of the components can be kept as long as possible or, in principle, made possible at all. Silicon carbide (SiC) is the main material used for such protective coating systems. The complete production of such components from a corrosion-resistant material, usually ceramic, is not possible or not financially feasible due to the size and complexity.

Commercially available SiC-coated graphite components are typically manufactured using chemical vapor deposition (CVD). On the one hand, however, particularly large and complex components are difficult to coat, as this requires very homogeneous gas flow conditions over the entire component surface. On the other hand, differences in the coefficient of thermal expansion CTE between the substrate and coating lead to the formation of cracks and coating detachment, especially under cyclic thermal stress (heating and cooling), which leads to increased corrosion of these components in use (see e.g., Park et al, “Enhancing the oxidation resistance of graphite by applying an SiC coat with crack healing at an elevated temperature”, Applied Surface Science, 378, 2016, pp. 341-349).

Other approaches to producing Siliciumcarbid coatings such as pack cementation (see e.g., Paccaud et al, “Silicon carbide coating by reactive pack cementation-Part II: Silicon monoxide/carbon reaction”, Chem. Vap. Deposition 2000, 6, No. 1, pp. 41-50) or the reactive infiltration of silicon (Si) melt (see e.g., EP 3 330 240 B1) offer the advantage of better layer adhesion with increasing CTE difference, but are not expedient in terms of layer quality, resource efficiency and implementation in large-scale production.

It should also be noted that the coating of graphite components is fundamentally very problematic and significantly more complicated than the coating of other materials, such as ceramic composites, so that coating methods known from the state of the art and used there for coating other substrates are generally not suitable for graphite substrates or graphite components. Graphite substrates have an open porosity of up to 25% by volume, whereby the porosity distribution within a component or a sample is not necessarily homogeneous. The lower porosity-compared to other materials, such as ceramic composites—in combination with the local porosity and associated density differences make the coating of graphite components more difficult, infiltration in particular being made considerably more difficult by the lower porosity of graphite compared to other materials, such as ceramic composites. As a result, the use of coating methods applied to substrates made of other materials, such as ceramic composites, generally does not lead to successful coating of graphite components.

### BRIEF SUMMARY OF THE INVENTION

Based on this, it was the task of the present invention to provide a process for the treatment of porous graphite substrates, with which substrates with an increased resistance can be obtained.

This object is solved by the features of the method for treating porous substrates described herein, and by the features of the treated substrate also described herein and the advantageous developments thereof. Possible uses of the treated substrate according to the invention are. also described.

### BRIEF DESCRIPTION OF THE DRAWINGS

FIG. 1 shows an example of differences in the coating morphology and sample coverage between the spray-coated and film-coated samples. FIG. 1 left shows a better corner and edge coating obtained by film coating than with spray coating, as the crystalline area is distributed over the entire sample surface, both at the corners and on the side surfaces. With spray coating, the corner and edge regions are less crystalline than the side surfaces (FIG. 1 right).

FIG. 2 shows the normalized layer thicknesses of the silicon carbide (SiC) layer obtained by film coating and spray coating methods, as determined by optical microscopy on cross-sections vertical to the infiltration direction and averaged over the entire sample length (5 cm)

FIG. 3 shows the SiC layer thickness normalized to SiC layer thickness mean value of the non-edge region for samples coated by spray coating and film coating.

FIG. 4, left vertical axis, shows the mass of coating layer normalized to initial mass as a function of the holding time at 1100° C. in synthetic air, and the right vertical axis shows the reduction in mass, for samples coated by film coating and spray coating.

### DETAILED DESCRIPTION OF THE INVENTION

According to the invention, a process for the (surface) treatment of porous graphite substrates is thus disclosed, in which
a) at least one film is provided, wherein the at least one film comprises silicon particles and at least one binding agent,
b) the at least one film is applied to at least one surface of a porous graphite substrate, and
c) the at least one applied film is subjected to at least one heat treatment in which the silicon particles melt to form a melt which (at least) partially infiltrates into pores of the porous graphite substrate, the silicon contained in the melt being at least partially, preferably completely, converted into silicon carbide, preferably polycrystalline silicon carbide.

In step a) of the method according to the invention, at least one film is provided. The at least one film contains silicon particles and at least one binding agent. Preferably, the at least one film may also contain at least one plasticizer. In addition, it is optionally possible for the at least one film to contain further components, such as at least one defoamer (e.g., fatty alcohol polyalkylene glycol ether), at least one dopant, and/or at least one surfactant (or modifier to reduce the surface tension). The at least one film may, for example, comprise the silicon particles, the at least one binding agent, optionally at least one plasticizer, optionally at least one defoamer (e.g., fatty alcohol polyalkylene glycol ether), optionally at least one dopant, and optionally at least one surfactant (or modifier to reduce the surface tension). Preferably, the silicon particles contained in the at least one film are silicon granules or silicon powder, particularly preferably silicon granules.

In this context, a binding agent can generally be understood as a substance that creates or promotes chemical bonds at phase boundaries of other substances or triggers or increases effects such as cohesion, adsorption and adhesion or friction.

The at least one binding agent ultimately serves to ensure that the silicon particles adhere to each other, thus ensuring the stability or cohesion of the at least one film. An optional plasticizer contained in the film can increase the flexibility of the film. However, it is also possible (alternatively or additionally) for the at least one binding agent to act as a plasticizer and thus ensure a certain flexibility of the film. It is also possible that the film contains neither a plasticizer nor that at least one binding agent acts as a plasticizer.

Preferably, a suspension based on a solvent (e.g., water) can be used as a base for the production of the at least one film, which contains silicon particles (e.g., with an average particle size d50 of 1 to 2000 μm) and at least one binding agent (e.g., carboxymethyl cellulose CMC or polyvinyl alcohol PVA) and optionally at least one plasticizer (e.g., polyethylene glycol PEG). An exemplary production of the film can then be carried out in such a way that the suspension is processed into a film, e.g., by means of doctor blades or film casting, the thickness of which can be e.g., 500 to 5000 μm, whereby after drying and removal of the solvent this results in a (flexible) film with embedded Si particles. The density per unit area of the film can be determined (or adjusted) by the thickness of the film or the proportion of Si solid used.

In step b) of the method according to the invention, the at least one film is applied to at least one surface of a porous graphite substrate. The film can be applied to the surface, for example, by wetting with a solvent that is capable of dissolving the at least one binding agent and preferably also other organic components of the film (e.g., an optionally present plasticizer), followed by application and pressing of the film and drying of the film. The at least one binding agent can be reactivated by drying and allows a firm bond with the substrate after drying. Preferably, the film can be cut, punched or folded into any desired shape before, during and/or after step b). It is also possible, for example, for several films or pieces of film to be used and for the films or pieces of film to be extended, widened, stacked and/or laminated as desired by coating or spraying with solvent at the ends or surfaces to be joined. Preferably, silicon solid (or the silicon particles) can be recovered from residual pieces of the film by dissolving and washing in solvent, processed and reused. Water, for example, can be used as a solvent. In step b), the at least one film may be applied to the at least one surface of the porous graphite substrate such that (after application) it adjoins at least one edge of the substrate, i.e., the applied at least one film adjoins at least one edge of the substrate. Preferably, in step b), the at least one film is applied to the at least one surface of the porous graphite substrate such that it completely covers the at least one surface of the porous graphite substrate.

In step c) of the method according to the invention, the at least one applied film is subjected to at least one heat treatment. In the at least one heat treatment, the silicon particles melt to form a melt, wherein the melt partially infiltrates into pores of the porous graphite substrate and wherein silicon contained in the melt reacts at least partially, preferably completely, (with the carbon from the porous graphite substrate) to form silicon carbide, preferably polycrystalline silicon carbide. In this case, the melt only partially infiltrates into the pores of the porous graphite substrate, i.e., not all of the melt infiltrates into the pores of the porous substrate. Instead, a silicon carbide layer is formed on the at least one surface from a part of the melt that has not infiltrated into the pores of the porous graphite substrate (whereas silicon carbide arranged in the pores is formed from a part of the melt that has infiltrated into the pores of the porous graphite substrate). The substrate ultimately obtained (or produced by the method according to the invention) thus has a silicon carbide layer on the treated surface (or the at least one surface) and an infiltration zone underneath, in which the pores (of the graphite material) are at least partially filled with silicon carbide (or contain silicon carbide). The combination of the (superficial) silicon carbide layer and the infiltration zone with the pores (at least partially) filled with silicon carbide (or containing silicon carbide) can also be referred to as a protective layer.

The substrate produced by the method according to the invention has a very low gas permeability due to the protective layer mentioned (i.e., the combination of the (superficial) silicon carbide layer and the infiltration zone (at least partially) filled with silicon carbide (or containing silicon carbide)) and is preferably completely impermeable to gas. In this case, the penetration of gases or fluids into the material and, accordingly, interaction with corrosive media (e.g., oxygen), which would lead to degradation of the carbon material of the substrate, can be prevented by almost or essentially complete sealing of the treated surface or almost or essentially complete closure of the pores near the surface. This contributes to an increased resistance of the substrates obtained with the process according to the invention. In addition, due to the silicon carbide layer and the presence of the silicon carbide in the pores in the infiltration zone of the substrate, the substrate produced has both increased hardness and increased wear resistance, which also contributes to increased resistance.

In addition, the method according to the invention is characterized in particular by the fact that the silicon particles can be applied to the areas of the substrate to be treated with very high precision by using the at least one film. Compared to other application methods, e.g., CVD coating or application of particles by means of a suspension (e.g., by spray coating), a much more precise and targeted coating can be achieved, whereby ultimately a much more homogeneous protective layer (i.e., a more homogeneous silicon carbide layer and a more homogeneous infiltration zone) is obtained. Alternative application methods, such as the application of silicon particles to the substrate by means of an (aqueous) suspension (e.g., via a spray coating) result in the problem that the regions at the edges and corners of the substrate are not sufficiently coated, as a thinner coating film is formed there than at regions that are further away from the edges. This results in an inhomogeneous protective layer that is thinner in the regions at the edges of the substrate than in the remaining regions, which leads to lower resistance in the regions at the edges of the substrate. This can be prevented with the method according to the invention, since by using the at least one film, the silicon particles can be applied evenly over the entire desired area of the surface of the substrate to be treated and thus a sufficiently thick protective layer is also obtained in the areas at the edges and corners of the substrate. As a result, very homogeneous protective layers can be obtained over the entire desired area using the method according to the invention, which means that the desired resistance of the substrate can be achieved over the entire desired area of the substrate, in particular also in the areas at the edges and corners. This ultimately contributes to a further increase in the resistance of the substrates produced. For example, the substrates produced using the process according to the invention thus exhibit excellent oxidation resistance over a very long period of time. The excellent oxidation resistance is given over a longer period of time than with treated substrates, where the silicon particles are applied to the substrate by means of an (aqueous) suspension (e.g., by spray coating).

In the context of the present invention, it was found that the process according to the invention and the homogeneous protective layer obtained thereby surprisingly enable a very good coating of graphite substrates or graphite components. The coating of graphite substrates or graphite components is actually very problematic and considerably more complicated than the coating of other materials, such as ceramic composites, since coating, in particular infiltration, is considerably more difficult due to the lower porosity of graphite compared to other materials, such as ceramic composites. Another advantage of using at least one film is that the coating system can be precisely adjusted to the graphite properties (e.g., via the amount of silicon).

It should also be noted that the infiltration of the melt into the pores of the substrate and the resulting (at least partially) silicon carbide-filled (or silicon carbide-containing) pores result in an extremely strong bond strength, and cracking and delamination due to CTE differences can be significantly minimized or prevented. On the one hand, this results in a high coating quality and surface finish. On the other hand, by avoiding defects in the protective layer—such as cracks and delamination—a reduction in resistance can be prevented.

Furthermore, the use of at least one film for applying the silicon particles also enables and simplifies the coating of substrates or components with very complicated geometries, since the at least one film can be adapted or cut to the desired shape and then easily placed without the risk of blurring or dripping, as is the case when applying a suspension. It is also possible to coat areas with different concentrations of silicon particles, for example by using a different number of films on top of each other and/or at least one film with areas with different concentrations of silicon particles in different areas.

In addition, the process according to the invention can also be used to repeatedly coat and recondition components that have already been used and have an degraded or damaged coating.

The simplified application process of the silicon particles through the use of the at least one film also leads to an increased component throughput and a reduction in the manufacturing costs per coated substrate or component and thus also to a simpler, faster and more cost-effective manufacturing process.

A preferred embodiment of the method according to the invention is characterized in that
the silicon particles have an average particle size d50 in the range from 1 μm to 2000 μm, preferably in the range from 50 μm to 1500 μm, particularly preferably in the range from 100 μm to 1000 μm, most preferably in the range from 510 μm to 950 μm (or from more than 500 μm to 950 μm), in particular in the range from 600 μm to 900 μm, and/or
the at least one film has a thickness of at least 500 μm (or of more than 500 μm), preferably in the range from 500 μm to 5000 μm (or of more than 500 μm and up to 5000 μm), particularly preferably in the range from 600 μm to 4000 μm, most preferably in the range from 700 μm to 3000 μm, in particular in the range from 800 μm to 2000 μm.

Such a thickness of the at least one film can achieve a particularly high resistance of the treated substrates in the case of graphite substrates.

The average particle size d50 of the silicon particles can be determined using laser diffraction, for example (e.g., in accordance with ISO 13320:2020-01).

A further preferred embodiment of the method according to the invention is characterized in that the silicon particles have (over the entire area or all areas of the at least one film) a unimodal particle size distribution or (over the entire area or all areas of the at least one film) a multimodal particle size distribution, preferably a bimodal particle size distribution. For example, the silicon particles can have a multimodal particle size distribution, preferably a bimodal particle size distribution, and a first group of silicon particles with an average particle size in the d50 in the range from 1 μm to 50 μm, preferably in the range from 3 μm to 20 μm, and a second group of silicon particles with an average particle size in d50 in the range from 100 μm to 2000 μm, preferably in the range from 510 μm to 950 μm, or consisting thereof.

The particle size distribution and/or the mean particle size d50 of the silicon particles can, for example, be determined using laser diffraction (e.g., in accordance with ISO 13320:2020-01).

By using silicon particles with a multimodal or bimodal particle size distribution, a better fit and packing density of the silicon particles in the at least one film can be achieved, so that the at least one film has a higher silicon particle density and consequently a higher homogeneity, which ultimately results in an even more homogeneous protective layer (i.e., a more homogeneous silicon carbide layer and a more homogeneous infiltration zone) due to a more even and homogeneous surface coverage.

According to a further preferred embodiment, the silicon particles (over the entire area or over all areas of the at least one film) can have a unimodal particle size distribution. For example, the silicon particles (in the entire area or in all areas) of the at least one film can have an average particle size d50 in the range from 1 μm to 2000 μm, preferably in the range from 50 μm to 1500 μm, particularly preferably in the range from 100 μm to 1000 μm, most preferably in the range from 510 μm to 950 μm (or from more than 500 μm to 950 μm), in particular in the range from 600 μm to 900 μm.

A preferred embodiment of the method according to the invention is characterized in that the at least one film has at least one first region and at least one second region, wherein the silicon particles in the at least one second region have a mean particle size d50 which is larger than a mean particle size d50 of the silicon particles in the at least one first region, wherein preferably the mean particle size d50 of the silicon particles in the at least one first region is in the range from 1 μm to 50 μm, preferably in the range from 3 μm to 20 μm, and/or the mean particle size d50 of the silicon particles in the at least one second region is in the range from 100 μm to 2000 μm, preferably in the range from 510 μm to 950 μm.

By using silicon particles with different average particle sizes in different areas of the film, a better or higher surface coverage can be achieved for components with different thicknesses and/or complex geometries and/or strong local porosity differences, which can ultimately result in an even more homogeneous protective layer (i.e., a more homogeneous silicon carbide layer as well as a more homogeneous infiltration zone).

According to a further preferred embodiment, the silicon particles can have, in the entire regions (or in all regions) an average particle size d50 in the range from 1 μm to 2000 μm, preferably in the range from 50 μm to 1500 μm, particularly preferably in the range from 100 μm to 1000 μm, most preferably in the range from 510 μm to 950 μm (or from more than 500 μm to 950 μm), in particular in the range from 600 μm to 900 μm. For example, the silicon particles can have essentially the same average particle size d50 in all areas of the at least one film.

A further preferred embodiment of the method according to the invention is characterized in that the at least one film has at least one first region and at least one second region, wherein the at least one second region has a higher silicon concentration per unit area (or amount of silicon per unit area) than the at least one first region, preferably the at least one film has at least one third region which has a higher silicon concentration per unit area (or amount of silicon per unit area) than the at least one second region.

The silicon concentration per unit area (or silicon quantity per unit area) in the respective regions can be adjusted accordingly during the manufacture of the at least one film by using different silicon concentrations or silicon quantities in the respective regions. The silicon concentration per unit area (or silicon quantity per unit area) can be determined on the already produced film, for example, by cutting out pieces of film with a defined area and then weighing them. The defined areas are preferably more than 1 cm², particularly preferably more than 150 cm², very particularly preferably more than 250 cm².

According to a further preferred embodiment, the at least one film may have substantially the same silicon concentration per unit area (or amount of silicon per unit area) over its entire area or in all of its areas.

A further preferred embodiment of the method according to the invention is characterized in that the at least one film is provided in step a) by preparing at least one suspension comprising the silicon particles, the at least one binding agent and at least one solvent, preferably water, and optionally additionally at least one plasticizer, and processing the at least one suspension to form the at least one film, preferably by doctoring or film casting. In addition, it is optionally possible for the at least one suspension to contain further components, such as at least one defoamer (e.g., fatty alcohol polyalkylene glycol ether), at least one dopant, and/or at least one surfactant (or modifier to reduce the surface tension). The at least one suspension may, for example, consist of the silicon particles, the at least one binding agent, the at least one solvent (preferably water), optionally at least one plasticizer, optionally at least one defoamer (e.g., fatty alcohol polyalkylene glycol ether), optionally at least one dopant, and optionally at least one surfactant (or modifier to reduce the surface tension). Preferably, the silicon particles contained in the at least one suspension are silicon granules or silicon powder, particularly preferably silicon granules.

A further preferred embodiment of the method according to the invention is characterized in that
the at least one binding agent is selected from the group consisting of polyvinyl alcohol; polyethylene glycol; polyvinyl butyral; polyacrylic acid; polyurethane; polymethyl methacrylate; chloroprene rubber; phenolic resin; acrylic resin; cellulose; cellulose derivatives, preferably carboxymethyl cellulose, hydroxyethyl cellulose; alginic acid; dextrin; and mixtures thereof, wherein the at least one binding agent is preferably selected from the group consisting of polyvinyl alcohol, carboxymethyl cellulose, polyethylene glycol, and mixtures thereof, and/or
the at least one film comprises at least one plasticizer different from the at least one binding agent, wherein the at least one plasticizer is preferably selected from the group consisting of benzyl butyl phthalate, dibutyl phthalate, dimethyl phthalate, dioctyl phthalate, glycerol, polyvinylpyrrolidone, polypropylene glycol, octadecanoic acid butyl ester, and mixtures thereof.

A further preferred embodiment of the method according to the invention is characterized in that the at least one film
comprises 40 to 99.9% by weight, preferably 55 to 95% by weight, particularly preferably 60 to 90% by weight, of the silicon particles, based on the total weight of the at least one film, and/or
comprises 0.1 to 25% by weight, preferably 1 to 10% by weight, particularly preferably 3 to 5% by weight, of the at least one binding agent, based on the total weight of the at least one film, and/or
comprises 0 to 35% by weight, preferably 1 to 15% by weight, particularly preferably 5 to 10% by weight, of at least one plasticizer which differs from the at least one binding agent, based on the total weight of the at least one film.

A further preferred embodiment of the method according to the invention is characterized in that the at least one film comprises a composition with the following components:
40 to 99.9% by weight, preferably 60 to 97.9% by weight, particularly preferably 75 to 91% by weight, of the silicon particles,
0.1 to 25% by weight, preferably 1 to 10% by weight, particularly preferably 3 to 5% by weight, of the at least one binding agent,
0 to 35% by weight, preferably 1 to 15% by weight, particularly preferably 5 to 10% by weight, of at least one plasticizer different from the at least one binding agent, based on the total weight of the at least one film,
0 to 35% by weight, preferably 0.1 to 15% by weight, particularly preferably 1 to 10% by weight, of at least one additive selected from the group consisting of defoamers (e.g., fatty alcohol polyalkylene glycol ethers), dopants, surfactants (or modifiers to reduce the surface tension), and mixtures thereof, the proportions of the components adding up to 100% by weight.

A further preferred embodiment of the method according to the invention is characterized in that
the at least one film is cut, punched and/or folded before, during and/or after step b), and/or
the at least one film comprises at least two films which are joined together before, during and/or after step b).

A further preferred embodiment of the method according to the invention is characterized in that the at least one film is applied to the at least one surface of the porous graphite substrate in step b) by first wetting the at least one surface of the porous graphite substrate and/or the at least one film with at least one solvent in which the at least one binding agent is at least partially soluble, preferably water, then the at least one film is brought into contact with the at least one surface of the porous graphite substrate, and the at least one film in contact with the at least one surface of the porous substrate is subjected to at least one drying process, the at least one drying process preferably taking place at a temperature in the range from 10° C. to 200° C., preferably from 80° C. to 100° C., and/or over a period of 15 minutes to 48 hours, preferably from 1 hour to 12 hours.

A further preferred embodiment of the method according to the invention is characterized in that the at least one heat treatment
is carried out at a temperature in the range from 1400° C. to 1800° C., preferably from 1410° C. to 1700° C., particularly preferably from 1450° C. to 1550° C., and/or
is carried out over a period of 1 h to 10 h, preferably 4 h to 6 h, and/or
is carried out under vacuum or under an inert gas atmosphere, preferably an argon atmosphere, at a (process) pressure of 10 mbar to 2000 mbar, preferably from 100 mbar to 1800 mbar, particularly preferably from 500 mbar to 1500 mbar, most preferably from 800 mbar to 1200 mbar.

By varying the gas atmosphere, the temperature, the duration and/or the process pressure, the thickness of the infiltration zone and thus also the degree of sealing or the gas permeability can be influenced and adjusted.

A further preferred embodiment of the method according to the invention is characterized in that
the porous graphite substrate is a porous iso-graphite substrate, and/or
the porous graphite substrate comprises or consists of a graphite material which has a coefficient of thermal expansion of at least 2.8·10⁻⁶ K⁻¹, preferably of at least 3.0·10⁻⁶ K⁻¹, particularly preferably of at least 3.2·10⁻⁶ K⁻¹, and/or
the porous graphite substrate has an open porosity, measured by mercury porosimetry, of at least 12%, preferably from 12% to 30%, particularly preferably from 14% to 25%, very particularly preferably from 15% to 20%, and/or
the pores of the porous graphite substrate have an average pore diameter in the range from 0.1 μm to 10 μm, preferably from 1 μm to 5 μm, particularly preferably from 1.5 μm to 5 μm.

The coefficient of thermal expansion (or thermal expansion coefficient) can be determined, for example, according to DIN 51909:2009-05.

The open porosity of the porous graphite substrate is determined by means of mercury porosimetry (e.g., in accordance with DIN 66133:1993-06).

The average pore diameter of the pores of the porous graphite substrate can be determined using mercury porosimetry (e.g., in accordance with DIN 15901-1:2019-03).

The present invention also relates to a treated substrate comprising a graphite material having pores, the substrate having on at least one surface a silicon carbide layer and an infiltration zone underneath (i.e., below the silicon carbide layer) in which the pores of the graphite material are at least partially filled with silicon carbide (or in which the pores of the graphite material (at least partially) contain silicon carbide), wherein the silicon carbide layer in at least one (preferably in each) region (of the silicon carbide layer) adjoining at least one edge of the treated substrate has a thickness which corresponds to at least 70% of the average thickness of the (entire) silicon carbide layer. Preferably, the at least one region (of the silicon carbide layer) adjoining at least one edge of the treated substrate extends (from the at least one edge) to a distance measured from the at least one edge,
of 2 mm, preferably 4 mm, particularly preferably 10 mm, and/or,
of 10%, preferably 20%, of the distance between the at least one edge and an edge of the substrate opposite the at least one edge.

The combination of the silicon carbide layer and the infiltration zone with the pores (at least partially) filled with silicon carbide (or containing silicon carbide) can also be referred to as a protective layer. In other words, the substrate has, on at least one surface, a protective layer comprising a silicon carbide layer and an infiltration zone underneath (i.e., under the silicon carbide layer) in which the pores of the graphite material are at least partially filled with (or contain) silicon carbide. The infiltration zone is located further inside the substrate than the silicon carbide layer, i.e., the protective layer comprises the silicon carbide layer as the outer part (located directly on the surface) and the infiltration zone as the inner part.

The infiltration zone is ultimately the area or areas of the treated substrate in which silicon carbide is present in the pores of the graphite material. No silicon carbide is present in the pores of the graphite material in the area(s) of the treated substrate outside the infiltration zone. The infiltration zone thus extends from the silicon carbide layer (or from the inner edge of the silicon carbide layer) to the point(s) of the treated substrate furthest from the at least one surface, up to which silicon carbide is present in the pores of the substrate material (continuous from the silicon carbide layer).

The thickness of the silicon carbide layer (at a specific point) and/or the average thickness of the silicon carbide layer can be determined, for example, by optical microscopy on cross sections (vertical to the direction of infiltration), e.g., in accordance with DIN EN ISO 1463:2021-08.

The average thickness of the silicon carbide layer can be determined, for example, by determining individual measured values for the thickness of the silicon carbide layer at various points distributed over the entire length and/or width of the silicon carbide layer using optical microscopy on cross sections and then calculating an average of the individual measured values.

Preferably, the silicon carbide layer has an average thickness of at least 10 μm, preferably from 10 μm to 10,000 μm, particularly preferably from 100 μm to 2,000 μm.

Preferably, the treated substrate according to the invention can be produced or is produced by the method according to the invention.

It is preferred that
the at least one edge in each case has an edge radius in the range from R₀ (or 0 mm) to R₅ (or 5 mm), preferably from R_{0.5} (or 0.5 mm) to R₄ (or 4 mm), particularly preferably from R₁ (or 1 mm) to R₃ (or 3 mm), and/or
an angle between two surfaces forming at least one edge is in the range from 10° to 170°, preferably from 30° to 150°, particularly preferably from 45° to 135°.

The edge radius and/or the angle between two surfaces forming at least one edge can be determined, for example, in accordance with DIN EN ISO 13715:2020-01.

A preferred embodiment of the treated substrate according to the invention is characterized in that the treated substrate
has a (gas) permeability of maximum 1·10⁻¹⁶ m², preferably of maximum 1·10⁻¹⁷ m², particularly preferably of maximum 1·10⁻¹⁸ m², especially preferably of maximum 1·10⁻¹⁹ m², and/or
has a (gas) permeability which is lower by a factor of at least 10, preferably at least 100, than a (gas) permeability of the substrate before treatment, and/or
has an open porosity in the infiltration zone, determined by means of mercury porosimetry, of a maximum of 10%, preferably a maximum of 8%, particularly preferably a maximum of 5%, and/or
has an open porosity in the infiltration zone, determined by mercury porosimetry, which is lower by at least 7%, preferably by at least 10%, particularly preferably by at least 12%, relative to the total volume of the treated substrate, than an open porosity of the treated substrate outside the infiltration zone, and/or
has a resistivity of at most 1500 mΩcm, preferably at most 10 mΩcm, and/or
the treated substrate has an oxidation resistance which is characterized in that, after exposure of the treated substrate for more than 162 h, preferably for more than 170 h, more preferably for more than 180 h, most preferably for more than 190 h, at 1100° C. in synthetic air (200 ml/min, 1 bar), a decrease in mass of the treated substrate is less than 0.72%, preferably less than 0.5%, particularly preferably less than 0.3%, most preferably less than 0.2% (based on the mass of the treated substrate before exposure to the synthetic air at 1100° C.), and/or
does not comprise elemental silicon, and/or
can be produced or is produced by the method according to the invention.

The (gas) permeability of the treated substrate and/or the (gas) permeability of the substrate before treatment can, for example, be determined using the differential pressure method (e.g., in accordance with EN 993-4:1995).

The presence of the characteristic that the treated substrate has a (gas) permeability that is lower by a factor of at least 10, preferably at least 100, than the (gas) permeability of the substrate before treatment can, for example, only be determined on the treated substrate by first measuring the (gas) permeability of the treated substrate, e.g., by means of a differential pressure method (e.g., according to EN 993-4:1995), then the silicon carbide layer and the infiltration zone are removed from the treated substrate, e.g., by grinding, then the (gas) permeability of the resulting substrate without the silicon carbide layer and infiltration zone is measured, e.g., using the differential pressure method (e.g., in accordance with EN 993-4:1995), and finally the two determined (gas) permeabilities are compared with each other or set in a corresponding ratio. The (gas) permeability of the treated substrate, from which the silicon carbide layer and the infiltration zone have been removed, corresponds to the (gas) permeability of the untreated substrate.

The open porosity in the infiltration zone of the treated substrate and the open porosity of the treated substrate outside the infiltration zone can be determined by means of mercury porosimetry (e.g., according to DIN 66133:1993-06).

The open porosity of the treated substrate outside the infiltration zone corresponds to the open porosity of the untreated substrate (also in the area of the later infiltration zone).

The resistivity of the treated substrate can be determined, for example, in accordance with DIN IEC 60413/402.

Preferably, the treated substrate contains less than 5% by volume, preferably less than 3% by volume, particularly preferably less than 1% by volume, of elemental silicon. Preferably, the treated substrate does not contain any elemental silicon. This can be determined using X-ray diffraction (XRD) or energy dispersive X-ray spectroscopy (EDX), for example.

A further preferred embodiment of the treated substrate according to the invention is characterized in that
the graphite material is an iso-graphite material, and/or
the infiltration zone has an average thickness of at least 100 μm, preferably from 100 μm to 1200 μm, particularly preferably from 200 μm to 800 μm, and/or
the silicon carbide with which the pores of the graphite material in the infiltration zone are at least partially filled comprises 3C-SiC, preferably has 3C-SiC as the main phase, and/or
a local concentration of silicon carbide in the infiltration zone decreases with increasing distance from the at least one surface, and/or
the infiltration zone has at least one first region and at least one second region, the at least one second region being equidistant from the at least one surface as the at least one first region and having a higher silicon carbide concentration per unit volume (or amount of silicon carbide per unit volume) than the at least one first region, wherein preferably the at least one infiltration zone has at least one third region which is equidistant from the at least one surface as the at least one second region (and the at least one first region) and has a higher silicon carbide concentration per unit volume (or amount of silicon carbide per unit volume) than the at least one second region.

The fact that the silicon carbide with which the pores of the graphite material in the infiltration zone are at least partially filled contains 3C-SiC can be determined using X-ray diffraction (XRD), for example.

The fact that the silicon carbide with which the pores of the graphite material in the infiltration zone are at least partially filled has 3C-SiC as the main phase means that the silicon carbide with which the pores of the graphite material in the infiltration zone are at least partially filled has a 3C-silicon carbide phase and has no other phases which have a higher percentage by weight of the total silicon carbide with which the pores of the graphite material in the infiltration zone are at least partially filled than the 3C silicon carbide phase.

The fact that the silicon carbide with which the pores of the graphite material in the infiltration zone are at least partially filled contains 3C-SiC as the main phase can be determined, for example, by means of X-ray diffraction (XRD).

3C-SiC (3C silicon carbide) may also be referred to as β-SiC (β-silicon carbide).

Preferably, the silicon carbide with which the pores of the graphite material in the infiltration zone are at least partially filled has a proportion of at least 50 wt.-%, preferably a proportion of at least 70 wt.-%, particularly preferably a proportion of at least 90 wt.-%, most preferably a proportion of at least 95 wt.-%, for example a proportion of at least 99 wt.-%, 3C-SiC (3C-silicon carbide) or β-SiC (β-silicon carbide), respectively.

Preferably, the silicon carbide with which the pores of the graphite material in the infiltration zone are at least partially filled has a content of at most 5% by weight, preferably a content of at most 1% by weight, particularly preferably a content of at most 0.1% by weight, α-SiC (α-silicon carbide). Very preferably, the silicon carbide with which the pores of the graphite material in the infiltration zone are at least partially filled does not contain α-SiC (α-silicon carbide).

The proportion of 3C-SiC or β-SiC and/or the proportion of β-SiC in the silicon carbide with which the pores of the graphite material in the infiltration zone are at least partially filled can, for example, be determined using X-ray diffraction (XRD).

The local concentration of silicon carbide in the infiltration zone and/or the silicon carbide concentration per unit volume (or amount of silicon carbide per unit volume) in a region (e.g., in at least one first region, in at least one second region, and/or in at least one third region) of the infiltration zone can be determined by means of energy dispersive X-ray spectroscopy (EDX).

It is preferred that the silicon carbide layer has a thickness in each region (of the silicon carbide layer) adjoining at least one edge of the treated substrate which corresponds to at least 70% of an average thickness of the silicon carbide layer.

A further preferred embodiment of the treated substrate according to the invention is characterized in that
the silicon carbide layer in the at least one (preferably in each) region (of the silicon carbide layer) adjoining at least one edge of the treated substrate has a thickness which is at least 75%, preferably at least 80%, particularly preferably at least 85%, especially preferably at least 90%, and/or at most 125%, preferably at most 120%, especially preferably at most 115%, particularly preferably at most 110%, in particular at most 105%, of the average thickness of the (entire) silicon carbide layer, preferably the at least one region (of the silicon carbide layer) adjoining at least one edge of the treated substrate extends (from the at least one edge) to a distance measured from the at least one edge,
0 of 2 mm, preferably 4 mm, particularly preferably 10 mm, and/or
of 10%, preferably 20%, of the distance between the at least one edge and an edge of the substrate opposite the at least one edge, and/or
the silicon carbide layer has a thickness at all points (of the silicon carbide layer) which are at most 2 mm, preferably at most 4 mm, particularly preferably at most 10 mm, away from at least one edge of the treated substrate, which is at least 70%, preferably at least 75%, particularly preferably at least 80%, especially preferably at least 85%, in particular at least 90%, and/or at most 125%, preferably at most 120%, particularly preferably at most 115%, especially preferably at most 110%, in particular at most 105%, of the average thickness of the (entire) silicon carbide layer, and/or
the silicon carbide layer has a thickness at all points (of the silicon carbide layer) which are at most 10%, preferably at most 20%, of the distance between the at least one edge and an edge of the substrate opposite the at least one edge, which thickness is at least 70%, preferably at least 75%, particularly preferably at least 80%, most preferably at least 85%, in particular at least 90%, and/or at most 125%, preferably at most 120%, particularly preferably at most 115%, most preferably at most 110%, in particular at most 105%, of the average thickness of the (entire) silicon carbide layer.

A further preferred embodiment of the treated substrate according to the invention is characterized in that
the silicon carbide layer in the at least one (preferably in each) area (of the silicon carbide layer) adjoining at least one edge of the treated substrate has a thickness which is at least 75%, preferably at least 80%, particularly preferably at least 85%, especially preferably at least 90%, and/or at most 125%, preferably at most 120%, particularly preferably at most 115%, especially preferably at most 110%, in particular at most 105%, of the average thickness of the silicon carbide layer in at least one remaining region (of the silicon carbide layer) (i.e., at least one region of the silicon carbide layer not adjoining at least one edge of the treated substrate), wherein preferably the at least one region (of the silicon carbide layer) adjoining at least one edge of the treated substrate extends (from the at least one edge) to a distance, measured from the at least one edge,
1 0 of 2 mm, preferably 4 mm, particularly preferably 10 mm, and/or
0 of 10%, preferably 20%, of the distance between the at least one edge and an edge of the substrate opposite the at least one edge, and/or
the silicon carbide layer has a thickness at all points (of the silicon carbide layer) which are at most 2 mm, preferably at most 4 mm, particularly preferably at most 10 mm, away from at least one edge of the treated substrate which is at least 70%, preferably at least 75%, particularly preferably at least 80%, especially preferably at least 85%, in particular at least 90%, and/or at most 125%, preferably at most 120%, particularly preferably at most 115%, especially preferably at most 110%, in particular at most 105%, of the average thickness of the silicon carbide layer at the (or all) other points (i.e., the points that are more than 2 mm, or more than 4 mm, or more than 10 mm, away from at least one edge of the treated substrate), and/or
the silicon carbide layer has a thickness at all points (of the silicon carbide layer) which are at most 10%, preferably at most 20%, of the distance between the at least one edge and an edge of the substrate opposite the at least one edge, which thickness is at least 70%, preferably at least 75%, particularly preferably at least 80%, most preferably at least 85%, in particular at least 90%, and/or at most 125%, preferably at most 120%, particularly preferably at most 115%, most preferably at most 110%, in particular at most 105%, of the average thickness of the silicon carbide layer at the (or all) other points (i.e., the points which are more than 10%, or more than 20%, of the distance between the at least one edge and the edge of the substrate opposite the at least one edge).

A further preferred embodiment of the treated substrate according to the invention is characterized in that
the silicon carbide layer in the at least one (preferably in each) area (of the silicon carbide layer) adjoining at least one edge of the treated substrate has a thickness which is at least 75%, preferably at least 80%, particularly preferably at least 85%, especially preferably at least 90%, and/or at most 125%, preferably at most 120%, particularly preferably at most 115%, especially preferably at most 110%, in particular at most 105%, of the thickness of the silicon carbide layer in the (or in every) remaining region (of the silicon carbide layer) (i.e., at least one region of the silicon carbide layer not adjoining at least one edge of the treated substrate), wherein preferably the at least one region (of the silicon carbide layer) adjoining at least one edge of the treated substrate extends (from the at least one edge) to a distance measured from the at least one edge,
of 2 mm, preferably 4 mm, particularly preferably 10 mm, and/or
of 10%, preferably 20%, of the distance between the at least one edge and an edge of the substrate opposite the at least one edge, and/or
the silicon carbide layer has a thickness at all points (of the silicon carbide layer) which are at most 2 mm, preferably at most 4 mm, particularly preferably at most 10 mm, away from at least one edge of the treated substrate which is at least 70%, preferably at least 75%, particularly preferably at least 80%, especially preferably at least 85%, in particular at least 90%, and/or at most 125%, preferably at most 120%, particularly preferably at most 115%, especially preferably at most 110%, in particular at most 105%, of the thickness of the silicon carbide layer at all other points (i.e., at the points that are more than 2 mm, or more than 4 mm, or more than 10 mm, away from at least one edge of the treated substrate), and/or
the silicon carbide layer has a thickness at all points (of the silicon carbide layer) which are at most 10%, preferably at most 20%, of the distance between the at least one edge and an edge of the substrate opposite the at least one edge, which thickness is at least 70%, preferably at least 75%, particularly preferably at least 80%, most preferably at least 85%, in particular at least 90%, and/or at most 125%, preferably at most 120%, particularly preferably at most 115%, most preferably at most 110%, in particular at most 105%, of the thickness of the silicon carbide layer at all other points (i.e., the points which are more than 10%, or more than 20%, of the distance between the at least one edge and the edge of the substrate opposite the at least one edge).

A further preferred embodiment of the treated substrate according to the invention is characterized in that the silicon carbide layer at any point (of the silicon carbide layer) which is at least 4 mm, preferably at least 2 mm, particularly preferably at least 1 mm, most preferably at least 0.5 mm, away from the at least one edge of the treated substrate has a thickness which is at least 70%, preferably at least 75%, more preferably at least 80%, more preferably at least 85%, in particular at least 90%, and/or at most 130%, preferably at most 125%, more preferably at most 120%, more preferably at most 115%, in particular at most 110%, of the average thickness of the (entire) silicon carbide layer.

A further preferred embodiment of the treated substrate according to the invention is characterized in that the silicon carbide layer has a thickness at each point (of the silicon carbide layer) which is at least 70%, preferably at least 75%, particularly preferably at least 80%, most preferably at least 85%, in particular at least 90%, and/or at most 130%, preferably at most 125%, particularly preferably at most 120%, most preferably at most 115%, in particular at most 110%, of the average thickness of the (entire) silicon carbide layer.

A further preferred embodiment of the treated substrate according to the invention is characterized in that
the average thickness of the silicon carbide layer has a standard deviation of maximum 50%, preferably of maximum 20%, particularly preferably of maximum 10%.

The thickness of the infiltration zone extends from the edge of the infiltration zone adjacent to the silicon carbide layer to the edge of the infiltration zone opposite the silicon carbide layer.

The thickness of the infiltration zone (at a specific point) and/or the average thickness of the infiltration zone can be determined, for example, by means of optical microscopy on cross-sections (vertical to the direction of infiltration), e.g., in accordance with DIN EN ISO 1463:2021-08.

The average thickness of the infiltration zone can be determined, for example, by determining individual measured values for the thickness of the infiltration zone at various points distributed over the entire length and/or width of the infiltration zone using optical microscopy on cross sections (vertical to the direction of infiltration) and then calculating an average of the individual measured values. The thickness of the infiltration zone can be averaged over the entire length and/or width of the infiltration zone.

Furthermore, the present invention also relates to the use of the treated substrate according to the invention as a component for high temperature furnaces, preferably heater, insulation component, holder; as crucible or crucible element.

The present invention is explained by the following figures and examples, without limiting the invention to the parameters specifically shown.

### Exemplary Embodiment 1

### a) Preparation of the Suspension

A film suspension with the following composition is produced:
57.9 wt. % H₂O dist.
0.9% by weight carboxymethylcellulose (binding agent)
3.9% by weight polyethylene glycol 400 (plasticizer)
0.3% by weight fatty alcohol polyalkylene glycol ether (defoamer)
37.0% by weight silicon granules (d50 approx. 180 μm)

First, the distilled water (H₂O dist.) and the binding agent are weighed out and placed in a container. To homogenize and dissolve the binding agent, the suspension is shaken by hand until there are no more lumps at the bottom of the container. The plasticizer is then weighed out and added. For homogenization, the suspension is transferred to the roller stand for 20 h at 30 rpm (vessel). The silicon granules and the defoamer are then weighed out and added to the suspension. To homogenize the suspension with solids content, it is placed on the roller stand at 30 rpm (vessel) for 15 min. The suspension is then processed into a film 1500 μm thick using doctor blades and dried for 24 hours at room temperature.

### b) Coating Process

A porous graphite substrate with an average pore diameter of 1.8 μm is provided. It has a substrate geometry of 5×5×1 cm³.

The film with a Si concentration of 0.055±0.005 g Si/cm² is applied to the surface (5×5 cm²) of the substrate by wetting the substrate surface with water and then placing and pressing the film onto it.

### c) Drying Process

The film-coated substrate is placed in the oven for 20 hours at 90° C. in air to dry.

### d) Infiltration Process

The dried substrate is placed in a graphitic sample chamber in an oven. The coated surfaces have no contact with the furnace internals. The oven volume is evacuated (10⁻³ mbar) and heated at 250 K/h from room temperature to 1500° C. The temperature of 1500° C. is maintained for 5 hours. This is followed by cooling from 1500° C. to room temperature at 200 K/h (cooling rate decreases from 700° C. to as low as 50 K/min because there is no active cooling) After cooling, the furnace volume is flooded with argon up to atmospheric pressure and the substrate is removed.

### Comparison Example 1

### a) Preparation of the Suspension

A spray suspension with the following composition is prepared:
66.7 wt. % H₂O dist.
0.3% by weight Peptapon 520 (binding agent)
33% by weight silicon granules (d50 approx. 800 μm)

First, the distilled water (H₂O dist.) and the binding agent are weighed out and placed in a container. For homogenization and dissolution of the binding agent, the suspension is aged for 20 h on the roller stand at 30 rpm (vessel). The silicon granules are then weighed out and added to the suspension. To homogenize the suspension with solids content, it is placed on the roller stand at 30 rpm (vessel) for 15 min.

### b) Coating Process

A porous graphite substrate with an average pore diameter of 1.8 μm is provided. It has a substrate geometry of 5×5×1 cm³.

The substrate is coated by spray application. The suspension is atomized by means of compressed air (4 bar). The suspension is fed by means of a nozzle (diameter 2.5 mm). The substrate is positioned with the surface to be coated perpendicular to the nozzle and thus to the direction of the spray jet, whereby the substrate is rotated at 10 rpm. The distance from nozzle to substrate surface is 20 cm. A constant application of 0.04+0.015 g Si/cm² is applied. After drying, the sample is turned so that a surface that has not yet been coated points vertically to the spray jet and this is coated in the same way. The process is repeated until all sides have been coated.

### c) Drying Process

The spray-coated substrate is placed in the oven for 20 hours at 90° C. in air to dry.

### d) Infiltration Process

The infiltration process is carried out in the same way as in embodiment example 1.

### Comparison and Analysis of the Treated Substrates Obtained in Embodiment 1 and Comparative Example 1

The treated substrates obtained all show no residues of elemental silicon on the respective treated surface and are therefore all characterized by a very high surface quality.

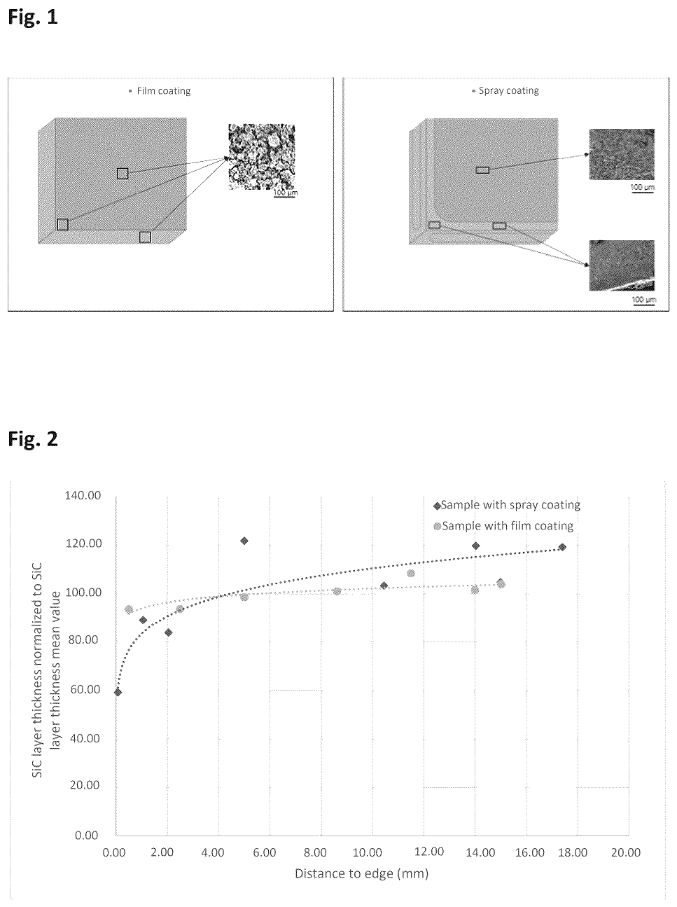

Images of the coated sample surfaces with a scanning electron microscope (SEM) show differences in the coating morphology and sample coverage between the spray-coated and film-coated samples. The differences are shown as an example in FIG. 1.

With film coating, a better corner and edge coating is evident than with spray coating, as the crystalline area is distributed over the entire sample surface, both at the corners and on the side surfaces (FIG. 1 left). With spray coating, the corner and edge regions are less crystalline than the side surfaces (FIG. 1 right).

To quantify the optical differences, layer thicknesses of the silicon carbide (SiC) layer were determined using optical microscopy on cross-sections vertical to the infiltration direction and averaged over the entire sample length (5 cm) (FIG. 2) and over the non-edge region (distance to the sample edge>10 mm) (FIG. 3).

In order to quantify the SiC layer thicknesses, the SiC layer thickness was calculated as a percentage of the average SiC layer thickness over the entire sample length.

At distances≤10 mm from the edge of the sample, the coating thickness is 59.0% to 121.7% for spray coating and 93.5% to 100.9% for film coating. At distances>10 mm from the edge of the sample, the coating thickness is 103.3% to 119.0% for spray coating and 101.4% to 108.3% for film coating.

| SiC layer thickness to mean value | Film coating | Spray coating |
|---|---|---|
| Distance 0-10 mm: | 93.5%-100.9% | 59.0%-121.7% |
| Distance >10 mm: | 101.4%-108.3% | 103.3%-119.0% |

For an additional quantification of the SiC layer thicknesses, the SiC layer thickness was calculated as a percentage of the average SiC layer thickness over the non-edge region.

At distances≤10 mm from the edge of the sample, the coating thickness is 52.9% to approx. 92.5% for spray coating and 89.5% to 96.6% for film coating. At distances >10 mm from the edge of the sample, the coating thickness is 92.5% to 106.6% for spray coating and 97.0% to 103.6% for film coating.

| SiC layer thickness to the mean | | |
|---|---|---|
| value in the non-edge region | Film coating | Spray coating |
| Distance 0-10 mm: | 89.5%-96.6% | 52.9%-92.5% |
| Distance >10 mm: | 97.0%-103.6% | 92.5%-106.6% |

The measured SiC layer thickness curves are shown in FIG. 2 and FIG. 3. Particularly at distances of up to 10 mm from the edge, a thinner SiC layer is formed with spray coating than with film coating. The significantly higher deviation in the spray-coated sample indicates a more inhomogeneous sample coverage near the edges compared to the film coating. These results are in good agreement with the observations from the SEM images.

### Exemplary Embodiment 2

### a) Preparation of the Suspension

A film suspension with the following composition is produced:
57.9 wt. % H₂O dist.
0.9% by weight carboxymethylcellulose (binding agent)
3.9% by weight polyethylene glycol 400 (plasticizer)
0.3% by weight fatty alcohol polyalkylene glycol ether (defoamer)
37.0% by weight silicon granules (d50 approx. 180 μm)

First, the distilled water (H₂O dist.) and the binding agent are weighed out and placed in a container. To homogenize and dissolve the binding agent, the suspension is shaken by hand until there are no more lumps at the bottom of the container. The plasticizer is then weighed out and added. For homogenization, the suspension is transferred to the roller stand for 20 h at 30 rpm (vessel). The silicon granules and the defoamer are then weighed out and added to the suspension. To homogenize the suspension with solids content, it is placed on the roller stand at 30 rpm (vessel) for 15 min. The suspension is then processed into a film 1500 μm thick using doctor blades and dried for 24 hours at room temperature.

### b) Coating Process

A porous graphite substrate with an average pore diameter of 1.8 μm is provided. It has a substrate geometry of 5×5×1 cm³.

The film is applied to the surface (5×5 cm²) of the substrate by wetting the substrate surface with water and then applying and pressing the film into place.

### c) Drying Process

The film-coated substrate is placed in the oven for 20 hours at 90° C. in air to dry.

### d) Infiltration Process

The dried substrates are placed in graphitic sample chamber in an oven. The coated surfaces have no contact with the furnace internals. The oven volume is evacuated (10-3 mbar) and heated at 250 K/h from room temperature to 1500° C. The temperature of 1500° C. is maintained for 5 hours. This is followed by cooling from 1500° C. to room temperature at 200 K/h (cooling rate decreases from 700° C. to as low as 50 K/min because there is no active cooling) After cooling, the furnace volume is flooded with argon up to atmospheric pressure and the substrates are removed.

### Comparison Example 2

### a) Preparation of the Suspension

A spray suspension with the following composition is prepared:
66.7 wt. % H₂O dist.
0.3% by weight Peptapon 520 (binding agent)
33% by weight silicon granules (d50 approx. 800 μm)

First, the distilled water (H₂O dist.) and the binding agent are weighed and placed in a vessel. For homogenization and dissolution of the binding agent, the suspension is aged for 20 h on the roller stand at 30 rpm (vessel). The silicon granules are then weighed out and added to the suspension. To homogenize the suspension with solids content, it is placed on the roller stand at 30 rpm (vessel) for 15 min.

### b) Coating Process

A porous graphite substrate with an average pore diameter of 1.8 μm is provided. It has a substrate geometry of 5×5×1 cm³.

When coating the substrate by spray application, the suspension is atomized using compressed air (4 bar). The suspension is fed by means of a nozzle (diameter 2.5 mm). The substrates are each mounted with the area to be coated (5×5 cm²) perpendicular to the nozzle and thus to the direction of the spray jet, with the respective substrate being rotated at 10 rpm. The distance from nozzle to substrate surface is 20 cm. Coating is carried out for all substrates with a spray time of 8 s. A constant application of 0.06±0.015 g suspension/cm² or 0.02+0.005 g Si/cm² is applied.

### c) Drying Process

The spray-coated substrate is placed in the oven for 20 hours at 90° C. in air to dry.

### d) Infiltration Process

The infiltration process is carried out in the same way as in exemplary embodiment 2.

### Comparison and Analysis of the Treated Substrates Obtained in Embodiment 2 and Comparative Example 2

The treated substrates obtained all show no residues of elemental silicon on the respective treated surface and are therefore all characterized by a very high surface quality.

To investigate the oxidation behavior, the spray-coated and film-coated substrates were exposed to synthetic air (200 ml/min, 1 bar) for up to 198 h at 1100° C. and the mass was determined at intervals of 6 and 24 h respectively.

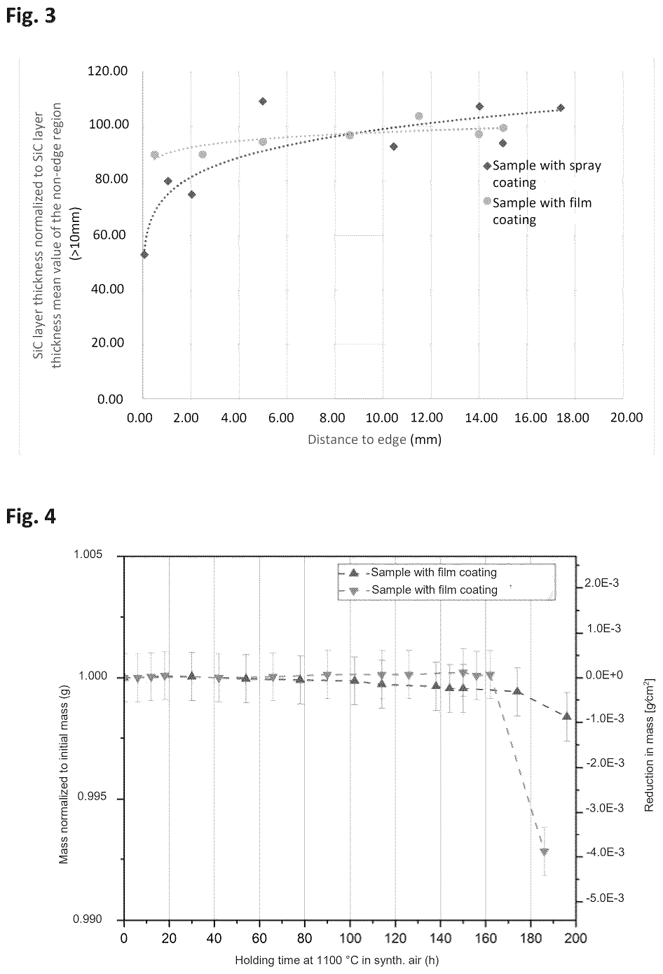

The results of this investigation of the oxidation behavior are summarized in FIG. 4. FIG. 4 shows the mass profile (left y-axis) and mass decrease profile (right y-axis) of spray-coated and film-coated samples as a function of the holding time at 1100° C. in synthetic air. The error bar refers exclusively to the left y-axis.

It is clear that no decrease in mass could be detected for the spray-coated sample after up to 162 h within the measurement accuracy (±0.001 g) or this was less than 5·10⁻³ g/cm² in relation to the sample surface. At holding times of more than 162 h, however, the spray-coated sample showed a mass reduction of 0.72%.

For the film-coated sample, no decrease in mass was detected up to 174 h, within the measurement accuracy (±0.001 g), or this was less than 5·10⁻³ g/cm² in relation to the sample surface. However, at holding times of over 162 h, the film-coated sample showed a maximum mass reduction of 0.16% at 198 h.

This investigation is proof of the enormous impermeability of the SiC layer, as well as the infiltration zone and thus the surface of the treated substrate.

Due to the more homogeneous sample coverage or SiC layer formation also in the sample edge region of the film coating, compared to spray coating, the oxidation behavior of such coated components can thus be significantly improved. This results in exceptionally high oxidation resistance due to a reduction in mass loss.

1-15. (canceled)

16. A method for treating porous graphite substrates, in which
(a) at least one film is provided, wherein the at least one film comprises silicon particles and at least one binding agent,
(b) the at least one film is applied to at least one surface of a porous graphite substrate, and
(c) the at least one applied film is subjected to at least one heat treatment in which the silicon particles melt to form a melt which partially infiltrates into pores of the porous graphite substrate, wherein silicon comprised in the melt is at least partially converted into silicon carbide.

17. The method according to claim 16, wherein the silicon particles have an average particle size d50 in the range from 1 μm to 2000 μm, and/or the at least one film has a thickness of at least 500 μm.

18. The method according to claim 16, wherein the at least one film has at least one first region and at least one second region, wherein the at least one second region has a higher silicon concentration per unit area than the at least one first region.

19. The method according to claim 18, wherein the at least one film has at least one third region which has a higher silicon concentration per unit area than the at least one second region.

20. The method according to claim 16, wherein the at least one film is provided in step a) by preparing at least one suspension comprising the silicon particles, the at least one binding agent and at least one solvent, and optionally additionally at least one plasticizer, and processing the at least one suspension to form the at least one film.

21. The method according to claim 16, wherein
the at least one binding agent is selected from the group consisting of polyvinyl alcohol, polyethylene glycol, polyvinyl butyral, polyacrylic acid, polyurethane, polymethyl methacrylate, chloroprene rubber, phenolic resin, acrylic resin, cellulose, carboxymethyl cellulose, hydroxyethyl cellulose alginic acid, and dextrin, and wherein
the at least one film comprises at least one plasticizer selected from the group consisting of benzyl butyl phthalate, dibutyl phthalate, dimethyl phthalate, dioctyl phthalate, glycerol, polyvinylpyrrolidone, polypropylene glycol, and octadecanoic acid butyl ester.

22. The method according to claim 16, wherein the at least one film
comprises 40 to 99.9% by weight of the silicon particles, based on the total weight of the at least one film, and/or
comprises 0.1 to 25% by weight of the at least one binding agent, based on the total weight of the at least one film, and/or
comprises 0 to 35% by weight of at least one plasticizer which differs from the at least one binding agent, based on the total weight of the at least one film.

23. The method according to claim 16, wherein
the at least one film is cut, punched and/or folded before, during and/or after step b), and/or
the at least one film comprises at least two films which are joined together before, during and/or after step b).

24. The method according to claim 16, wherein the application of the at least one film to the at least one surface of the porous graphite substrate is carried out in step b) by first wetting the at least one surface of the porous graphite substrate and/or the at least one film with at least one solvent in which the at least one binding agent is at least partially soluble, the at least one film is brought into contact with the at least one surface of the porous graphite substrate, and the at least one film in contact with the at least one surface of the porous substrate is subjected to at least one drying process.

25. The method according to claim 16, wherein the at least one heat treatment
is carried out at a temperature in the range from 1400° C. to 1800° C., and/or
is carried out over a period of 1 h to 10 h, and/or
is carried out under vacuum or under an inert gas atmosphere.

26. The method according to claim 16, wherein
the porous graphite substrate is a porous iso-graphite substrate, and/or
the porous graphite substrate comprises a graphite material which has a coefficient of thermal expansion of at least 2.8·10⁻⁶ K⁻¹, and/or
the porous graphite substrate has an open porosity, measured by mercury porosimetry, of at least 12%, and/or
the pores of the porous graphite substrate have an average pore diameter in the range from 0.1 μm to 10 μm.

27. A treated substrate comprising a graphite material having pores, the substrate having a silicon carbide layer on at least one surface and an underlying infiltration zone in which the pores of the graphite material are at least partially filled with silicon carbide, the silicon carbide layer having a thickness in at least one region adjoining at least one edge of the treated substrate which is at least 70% of the average thickness of the silicon carbide layer.

28. The treated substrate according to claim 27, which
has a permeability of maximum 1·10⁻¹⁶ m², and/or
has a permeability which is lower by a factor of at least 10, and/or
has an open porosity in the infiltration zone, determined by means of mercury porosimetry, of a maximum of 10%, and/or
has an open porosity in the infiltration zone, determined by mercury porosimetry, which is lower by at least 7%, relative to the total volume of the treated substrate, than an open porosity of the treated substrate outside the infiltration zone, and/or
has an oxidation resistance such that, after exposure of the treated substrate for more than 162 h, at 1100° C. in synthetic air (200 ml/min, 1 bar), a decrease in mass of the treated substrate is less than 0.72%, and/or
does not comprise elemental silicon.

29. The treated substrate according to claim 27, wherein
the graphite material is an iso-graphite material, and/or
the infiltration zone has an average thickness of at least 100 μm, and/or
the silicon carbide with which the pores of the graphite material in the infiltration zone are at least partially filled comprises 3C-SiC, and/or
a local concentration of silicon carbide in the infiltration zone decreases with increasing distance from the at least one surface, and/or
the infiltration zone comprises at least one first region and at least one second region, wherein the at least one second region is equidistant from the at least one surface as the at least one first region and has a higher silicon carbide concentration per unit volume than the at least one first region.

30. The treated substrate according to claim 27, wherein
the silicon carbide layer has a thickness in the at least one region adjoining at least one edge of the treated substrate which is at least 75% of the average thickness of the silicon carbide layer, and/or
the silicon carbide layer has a thickness at all points which are distanced by at most 2 mm of the average thickness of the silicon carbide layer, and/or
the silicon carbide layer has a thickness at all points which are distanced from at least one edge of the treated substrate by at most 10% of the distance between the at least one edge and an edge of the substrate opposite the at least one edge which corresponds to at least 70% of the average thickness of the silicon carbide layer.

31. A component of high temperature furnace comprising a treated substrate according to claim 27.
